(19) United States
(12) Patent Application Publication
(10) Pub. No.: US 2013/0332952 A1
(43) Pub. Date: Dec. 12, 2013

(54) Method and Apparatus for Adding User Preferred Information To Video on TV

(71) Applicants: Atul Anandpura, San Diego, CA (US); Sunil Solanki, San Diego, CA (US)

(72) Inventors: Atul Anandpura, San Diego, CA (US); Sunil Solanki, San Diego, CA (US)

(21) Appl. No.: 12/758,453

(22) Filed: Apr. 12, 2010

(51) Int. Cl. H04N 21/44

(52) U.S. Cl. CPC H04N 21/44
USPC 725/34

(57) ABSTRACT

An apparatus for combining any video and user-preferred data from the internet, a data collection processor, an on screen display generator and video mixer. The user-preferred data can be customized by the user on the apparatus or using a computer. The apparatus may be controlled by a remote control or hand or other gesture control may also used to control the apparatus. The apparatus also provides video conferencing mode. The apparatus provides speech to sign language conversion.

### FIELD OF THE INVENTION

The present invention relates to video presentation of user determined information. More particularly, it relates to an apparatus and method for collecting data regarding user-preferred information from the Internet, forming a combination of that data with the video that a user is watching, and simultaneously displaying them on a TV.

### BACKGROUND OF THE INVENTION

Sports fans are very eager to know the results of the sports for which they have an interest. Sports fans are also very eager to get the news related to their favored sports team. The Internet provides on-demand information through various websites. However, retrieving such information requires the use of a computer, laptop or mobile computing device. During the viewing of a sporting event, the computer is often located in the computer room of the home and the television in the family or entertainment room. This makes the use of a computer, during television viewing, awkward since the use of a portable laptop requires user distraction from the television program and the use of a desktop requires movement between the rooms to use the desktop computer.

Similarly, users with interest in stock quotes and other information would very much prefer to get some information instantaneously on such, without waiting for their computer to boot up, since stock prices change by the second. Such financial information is provided by several TV stations as a ticker tape at the bottom of the screen of displayed data which is generally about numerous companies. However, the user is not normally interested in all the information displayed at the bottom of the screen about companies other than those for which they have an interest. Instead, users would prefer to get customized, collected information according to their own inividualized preferences irrespective of the TV channel they are watching.

There are various solutions available to get the on-demand information on a desktop computer, laptop computer, notebook computer, netbook computer, mobile phones, smart phones or a PDA. With the invention of HDTV, there are some solutions available, which utilize the display ability of the HDTV set to function as a computer monitor. “Web TV” was originally invented by Microsoft as a manner to allow users to use Internet on their TV, however it essentially took over the screen and displayed only video concerning the internet. Both these solutions allow for the use and display of Internet information on the TV screen, however, if both are mutually exclusive in that they only allow display of the internet and do not allow the mixing of any video source chosen by the user in a display concurrent with the user preferred data in a scrolling text format.

U.S. Pat. No. 7,028,330 shows Internet video, but it does not provide on-demand scores and data as sports fans would want with any video on the TV display.

U.S. Pat. No. 6,886,178 teaches a system for digital TV with synchronized World Wide Web content, but it requires the data to be part of the original TV signal communicated by the broadcaster or provider as a single MPEG transport stream.

U.S. Pat. No. 6,785,906 provides for the above noted WebTV, but it requires a TV controller communicating with the Internet module. In addition, it does not provide the ease of viewing sports data chosen by the user, concurrent with the video chosen by the user as per current invention.

U.S. Pat. No. 7,590,998 provides a television system having Internet browsing capability, but it does not allow the for the use of a TV already installed in the user's home.

Consequently there is an unmet need for a device and method which allow for the concurrent viewing of user-preferred data, overlain upon the user preferred video being displayed on their home TV display. Such a device and method should allow the user to choose in a highly specific manner, the data to be mixed into and overlain on the displayed television program on the user's home TV screen. Such a system should allow users to employ their current television system without having to purchase a web-enabled television. Such a system should allow for engagement of a video generation device to the TV which does not require exclusive use of the TV display but will allow for concurrent display of the user-chosen program and user-chosen data for display.

With respect to the above, before explaining at least one preferred embodiment of the invention in detail or in general, it is to be understood that the invention is not limited in its application to the details of employment and to the arrangement of the components or the steps set forth in the following description or illustrated in the drawings. The various apparatus and methods of the herein disclosed invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for implementing electronic components and software which allow for concurrent display of user-chosen programming and highly customized streaming user-chosen data concurrently, on a single display screen, and for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

In accordance with the present invention, there is provided an apparatus and method to allow for the user to designate highly customized data concerning a subject, and to obtain user preferred data concerning the subject or subjects from the Internet. Employing software adapted to the task, and electronic components adapted to mix and overlay the customized data with any video, the disclosed system operates to allow the user to concurrently view their chosen television program, game, movie or other displayable media, at the same time as the overlain indicia of streaming data chosen by the user for retrieval from the Internet.

The system includes an electronic means to communicate with the Internet such as a computer or microprocessor having software adapted for such. Also employed are an audio processor, video processor, data processor, and video camera. Employing software and components adapted to combine the retrieved data with the user-chosen video being displayed, the disclosed device operates to mix the video being displayed for viewing concurrently with the user preferred data.

### OBJECTS OF THE INVENTION

It is an object of the invention to allow a user to designate specific data which they wish to view and to combine the user-preferred designated data from the Internet, with the video being displayed and which a user is watching on the TV.

It is another object of the invention to display the combined video with the user-preferred data on TV.

It is an additional object of the invention to provide such a composite of user video and user-chosen data with audio and video which are in synchronization with the combined video.

Yet another object of the invention to extract the information about the program from the video signal being watched, obtain the relevant information from the Internet, mix it with the video and display it on the TV.

A still further object of the invention is to display a web-link relevant to the program being watched.

It is another object of the invention to allow for the concurrent display any discussions going on the user's social networking sites along with chosen video.

A still further object of the invention is to provide means to ascertain durations of displayed programming which are advertisement breaks, and to provide detailed on-demand scores and statistics during the advertisement breaks of the TV program being watched.

Yet another object of the invention is to display advertisements based on the program content and user's preferences.

A further object of the invention is to send program information to other people with the comments.

It is another object of the invention to enable the user to rate the program being watched and communicate the user rating to agencies who have signed up for feedback services.

An additional object of the invention is to capture the image or short clip of a program and to provide means to send the captured video or image to user-chosen recipients.

It is another object of the invention to compress audio and video into a single signal and to stream the video to a mobile device on a local area network or on the internet.

Another object of the invention is to provide a means for video conferencing to the user.

A further object of the invention is to provide for a gesture based user interface to allow the user to control and operate the disclosed system.

It is another object of the invention is to enable speech challenged persons to communicate to other parties in the video conference call.

Finally, it is another object of the invention to enable a hearing challenged person to enjoy video watching through the projection of sign language concurrent with displayed video and synchronized with the displayed video.

The foregoing has outlined some of the more pertinent objects of the invention. These objects should be construed to be merely illustrative of some of the more prominent features and applications of the intended invention. Many other beneficial results can be attained by applying the disclosed method and device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of a system for displaying the combined video and user-preferred information on the TV;

FIG. 2 is a back perspective view of an apparatus which collects user-preferred data from the internet, formats data in text and graphics and overlays these text and data on the video input, and provides video combined with the overlaid data at the video output;

FIG. 3 is a front perspective view of an apparatus which collects user-preferred data from the internet, formats data in text and graphics and overlays these text and data on the video input, and provides video combined with the overlaid data at the video output;

FIG. 4 is a block diagram view of an apparatus illustrating how different blocks of the apparatus and system interact with each other;

FIG. 5 is a front view of a typical remote control to edit user's preferences for the data the apparatus need to collect from the internet;

FIG. 6 is a representation view of a TV showing a detailed statistics page for a sport;

FIG. 7 is a front view of a view of a typical mobile video player a user can use to view the combined video and data sent by the apparatus;

FIG. 8 is a schematic view of a system illustrating how an apparatus communicates with several data providers on the internet and collects user-preferred information to be displayed on TV;

FIG. 9 is a representation view of an apparatus with video camera capturing user's gesture;

FIG. 10 is a representation view of an apparatus in the video conference mode; and

FIG. 11 is a representation view of an apparatus converting audio input into sign language; and

FIG. 12 is a representation view of the menu items which may be presented to user to allow the user to input and specify their preference for the information each respective user would like to view while watching any TV program.

For purposes of clarity and brevity, like elements and components will bear the same designations and numbering throughout the figures.

### DETAILED DESCRIPTION OF THE PREFERRED EMBODIMENTS

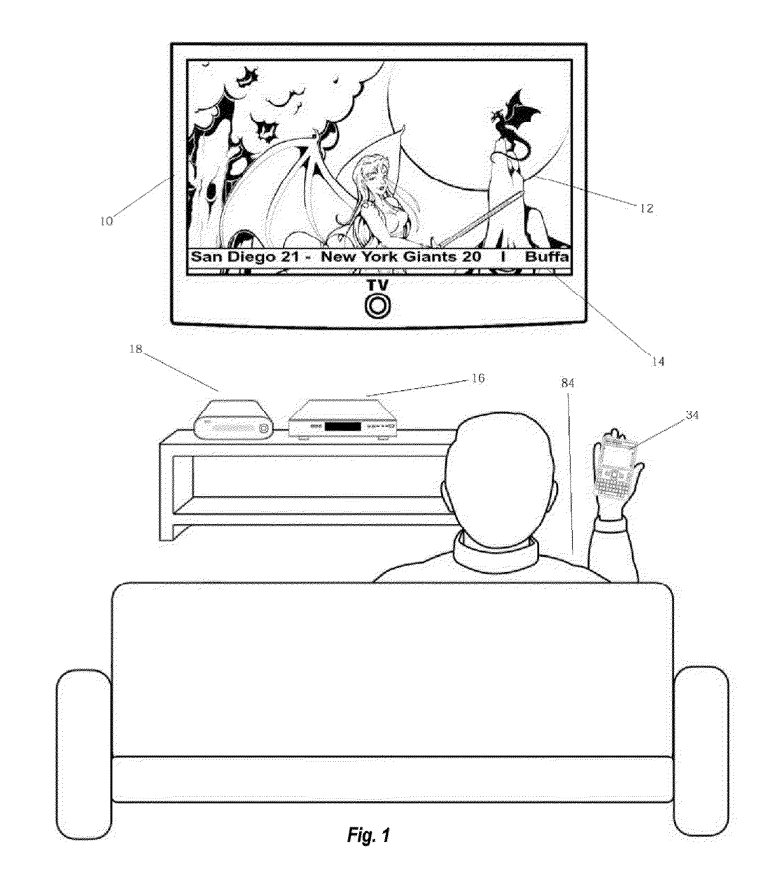

Referring now to the drawings 1-11, wherein similar parts of the invention are identified by like reference numerals, there is seen in FIG. 1 a schematic view of the system for combining the text and graphics of user chosen data retrieved from the internet or other networked source, to any video 12 chosen by the user or being displayed on the TV 10 screen.

The FIG. 1 depicts the TV 10 displaying any video 12 a user 84 may be watching. The video and audio signal is generated by the video source 16 which outputs the signal for display and use by the TV and accompany sound system. The means for communication of the video source 16 to the TV 10 can be any one of a group of such device including a set-top box or satellite receiver or cable system receiver or video cassette player or VCR player or DVD player or hard disk player or IPTV or any other source, which generates video which is in a format renderable upon a TV or Video screen.

Remote control 34 is employed by the user 84 to control the video source 16 and the disclosed device 18 herein. It is possible to have two separate remote controls to control the video source 16 and the device 18 independently. FIG. 1 also shows the user chosen or preferred data, retrieved from the internet or other source, overlaid on the input video 14 generated by the device 18 employing the video source 16 and the user preferred data signal. The user-preferred data overlaid on the input video 14 is generated as per the user's preferences for chosen data retrieved. This data can be live sports scores, historical sports score, weather information, traffic information, or a special promotional deal for the product of interest to the user 84.

This chosen data can also be inspirational quotes or divine quotes from the Bible or the Bhagwad Geeta or Koran or any other spiritual book. These quotes can also be live sermon text being delivered in a church or any other spiritual institution. The remote control 34 can also have a wireless receiver to play the same video a user 84 is watching. The device 18 transmits overlaid video to the TV 10 through some wired connections like HDMI or wirelessly using Wi-Fi or wireless technology suitable for HDTV transmission.

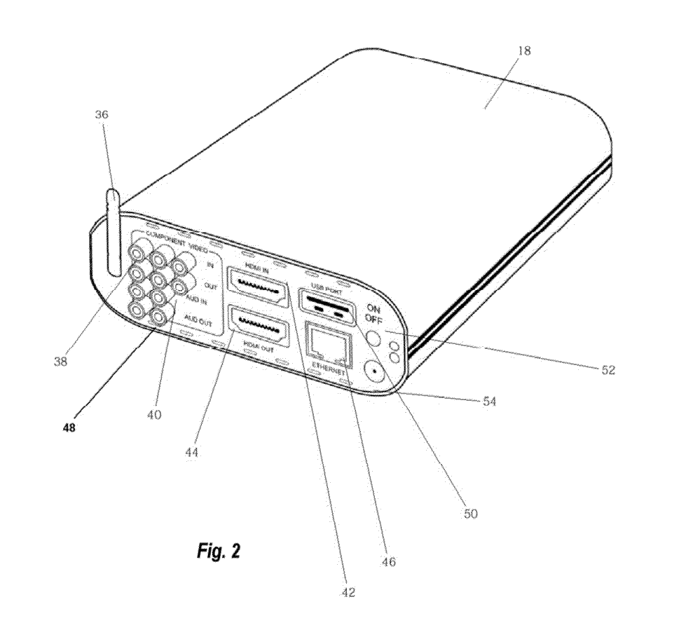

In FIG. 2 is shown a rear perspective of the device 18, with the video input 38 being either a composite video input 38 or a component video input 38. An HDMI input 42 allows the HDMI video source 16 to be connected to the device 18. Audio input 40 is connected to the audio generated by the video source 16. Audio output is connected to the audio input 40 of the TV 10 or any other audio amplifier or Hi-Fi system. Antenna 36 is used to connect to the WI-Fi or any other type of wireless internet 82 present in the house or office or any other dwellings where the device 18 is located. Ethernet connector 46 is used to connect the wired Local Area Network or Wired Wide Area Network. A USB port 50 can be used in many ways to connect to multiple peripherals including wired or wireless keyboard, wired or wireless mouse, and USB mass storage device. The power switch 52 is employable to control the electric power of the device 18. Power input 54 is used to connect the power supply to power the device 18.

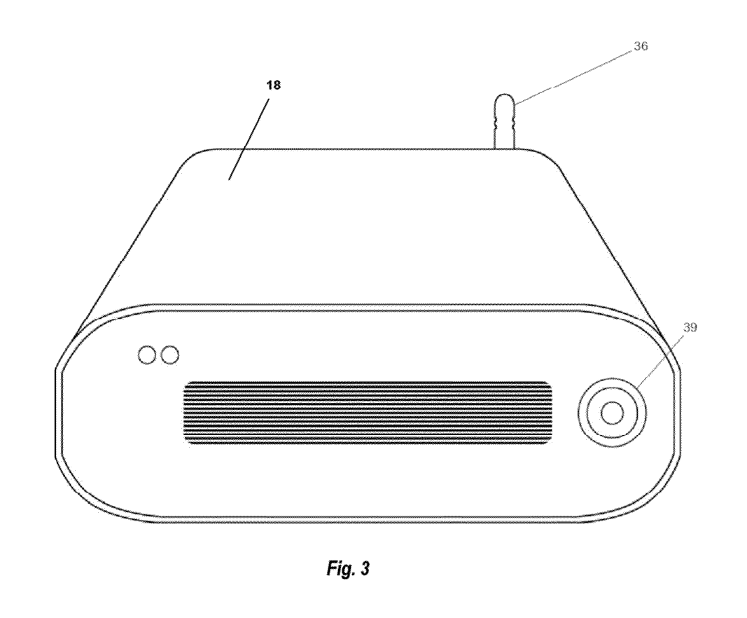

Shown in FIG. 3 is a front perspective view of the device 18. The device 18 shown here is a typical example. The front view shown here can be a rear view or side view of the device 18 also in alternate embodiments of the same invention.

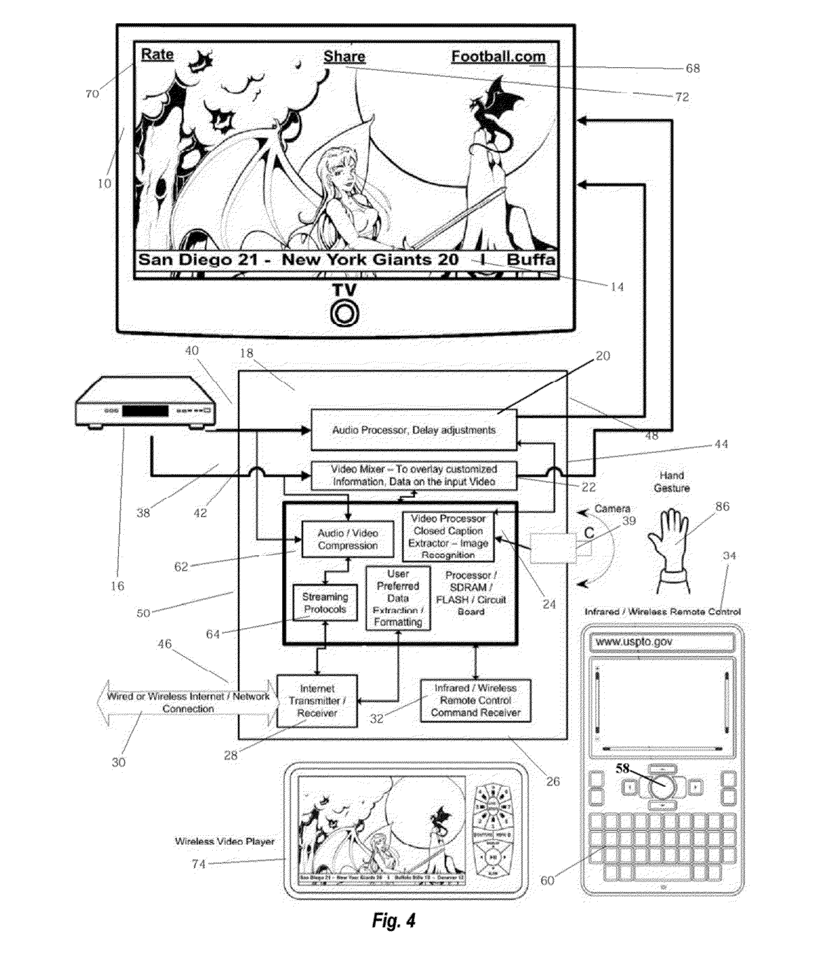

In FIG. 4 is a block diagram of the device 18 illustrating how different blocks of the device 18 and system interact with each other. The TV 10 shows a video picture. This video picture is produced by any video source 16. As noted above, the video source 16 can be any one of a group of such sources including a satellite TV receiver, cable TV receiver, IPTV, DVD player, VHS player or any other video source 16 which has either composite or component or HDMI or any other type of video output 44 which can be connected to the device 18. The user preferred data overlaid on the input video 14 is the information collected and prepared by the device 18. The TV 10 also shows the rate-link 70. The rate-link 70 enables the user 84 to rate the program they are watching. This rating information is communicated back to the ratings server or to the service provider server. This rating information is required by the program producer, distributor and advertisers for various reasons.

The share-link 72 enables the user 84 to share the information regarding the program to other users either through e-mail or through social networking websites; Clicking on share-link 72 activates a menu screen on the TV 10 and lets user input the way the user 84 would like to share the program information with other users. The web-link 68 is a URL address relevant to the user preferred information being displayed on the TV 10 or relevant to the program being watched.

Referring to the center of FIG. 4, the device 18 block diagram is shown. The device 18 consists of a circuit board 26, connectors and power supply. The circuit board 26 has a central processing unit similar to the ones used in computer, or smart mobile devices or combinations of ARM and DSP processor. The circuit board 26 also has SDRAM, Flash, audio video interface components, internet 82 connectivity components, and other required components required by the processors and various different peripherals of the processor. The processor on the circuit board 26 has embedded software which are adapted to provide the various disclosed functionalities to the device 18.

Video input 38 to the device 18 can be any type i.e. composite video or, component video or DVI video or HDMI video, or any other type of video format available at the time. The input video is fed into program information extractor 24 to extract the information embedded in the video file. This information is in the forms of Closed Captions or XDS or any other data type. The video processor extracts this program related information and the device 18 uses this information on its own or by communicating to the service provider server to display relevant web-link 68, share-link 72 and advertisements.

Video input 38 is also fed into the audio/video compressor 62 where the video is compressed in the form of H.264 or MPEG-4 or any other appropriate video compression technology. The video compression can be done either by the central processing unit on the circuit board 26 or through dedicated video compressor application specific integrated circuit (ASIC).

The processor collects various information from the internet 82 either through the general websites or through the service provider's server. User-preferred data extractor 24 and formatter screens this information to prepare and format the information according to the user's preference. Some example of this format are scrolling text display at the bottom of the screen or covering some part of the TV 10 display. User 84 has an ability to select various types of display formats through the remote control 34.

The formatted information is fed into the video mixer 22 where the input video is also fed. The video mixer 22 using analog or digital technology overlays the formatted user-preferred data on the input video. One example of such type of mixing is through On Screen Display (OSD) technology. The output of video mixer 22 is fed into video buffer amplifiers and connected to the TV 10 through video output 44 connectors.

Audio input 40 is fed into audio processor 20 and audio/video compressor 62 through appropriate buffer amplifiers and digitizer. The audio/video compressor 62 compresses audio signal using MP3, AAC or any other audio compression technology. Audio processor 20 adds delay in the audio path equivalent to the delay (if any) introduced by the video mixer 22 to ensure that the audio and video played on the TV 10 are in synchronization with each other. Output of audio processor 20 is fed into the Hi-Fi system attached to the TV 10 or into the audio input 40 of the TV 10.

The embedded software may also employ streaming protocols 64 to stream the compressed audio and video to local network. This enables the user 84 to view video wirelessly either within the local Wi-Fi or similar wireless network's range on a wireless video player. Streaming protocols 64 may also be configured to stream the video over the internet 82 so that user can view the video on the computer at a remote location or on a wireless media player 74.

The circuit board 26 may also have either or both of the USB connector and memory card connector to play the user's media to play on the TV 10. The USB connector can also be used to connect to external keyboard.

The processor controls the internet data transmitter/receiver 28 to communicate to the internet 82 for various functions like getting the data from the internet 82, providing users' information to various data providers, getting the firmware upgrade from the service provider's servers 78. The device 18 has wired or wireless network connection 30 connecting to the internet 82 through a router. An alternate embodiment of the invention may employ cellular data based wireless internet 82 connection.

The device 18 has remote control receiver 32 to receive the command and instructions from the remote control 34. The embedded software interprets commands from the remote control 34 and displays appropriate information or menu on the TV 10. The device 18 has a built in video camera 39. The video camera 39 is electrically connected to video processor and video mixer 22. The video processor captures video signal from the video camera 39 and it processes the user's gestures for controlling the user interface. In the video conference mode, the video camera 39 signal is captured by the video processor and passed on to the video compressor. Video compressor compresses the video.

The remote control's microphone 57 sends user's voice to audio processor 20. Audio processor 20 removes any back ground noise, eliminates audio clipping and sends processed audio signal to audio compressor. Audio compressor compresses audio signal. Combined audio video signal is routed to other users through SIP (simple Internet Protocol) server or appropriate server.

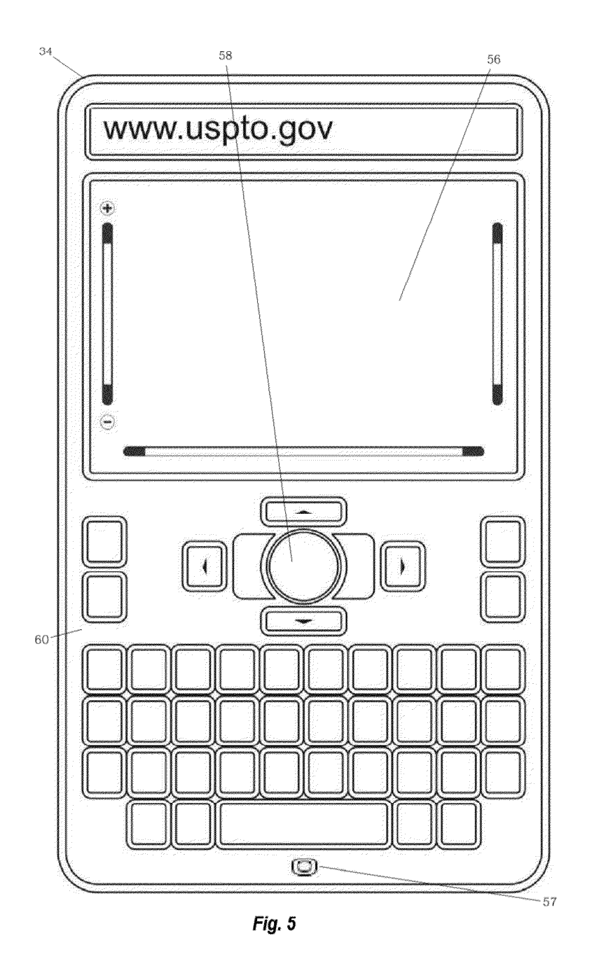

FIG. 5 is a front view of a typical remote control 34. Remote control 34 may have any or all of these input means: touchpad 56, scroll ball 58, and keypad 60. Remote control 34 is used to configure a user's profile and preferences through the menu displayed on the TV 10 screen. Alternatively, a user 84 can configure their profile and preferences through a computer, laptop, netbook or mobile devices, which can connect to the service provider's websites. The remote control 34 may have built in keypad 60 for the ease of entering the data. Optionally, remote control 34 may have a microphone 57 as well. Microphone 57 is used to provide voice when the device 18 is in video conference mode.

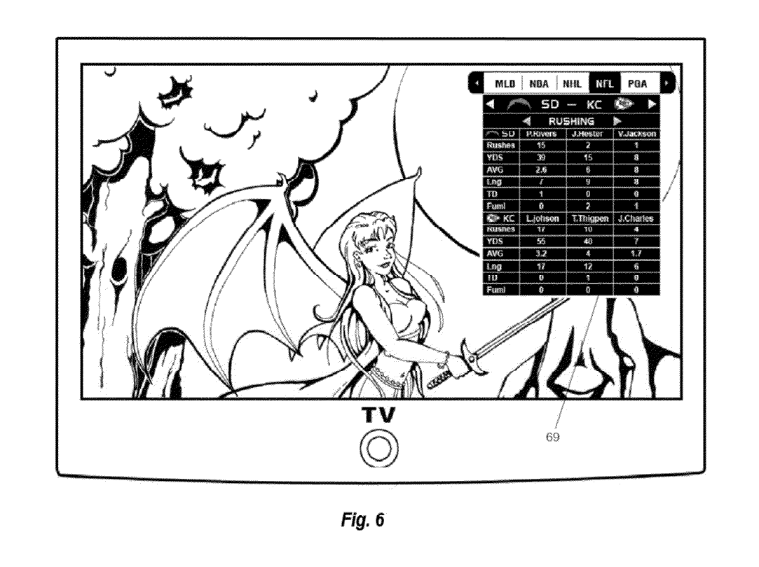

FIG. 6 is a representation of the TV 10 showing a detailed statistics 69 page for a sport.

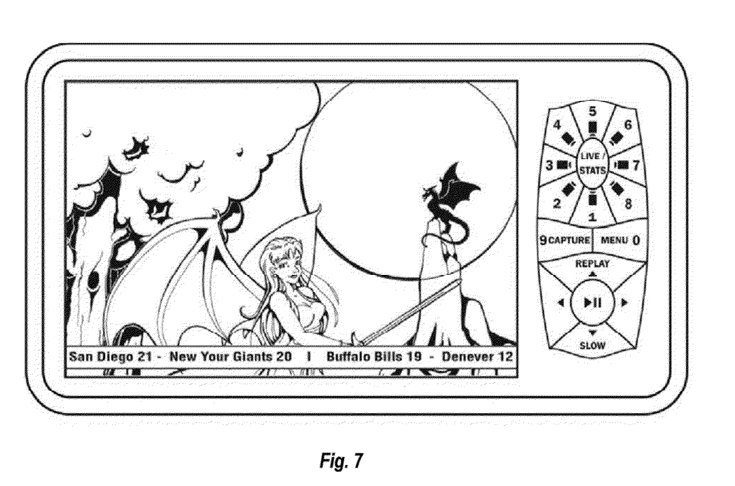

FIG. 7 shows a typical wireless media player 74, which can be used to play the audio and video sent by device 18 wirelessly to the device. The wireless technology may be 802.11b, 802.11g, 802.11n, DVB-H, ATSC-M/H, or any appropriate video technology suitable to transmit and receive streaming audio and video.

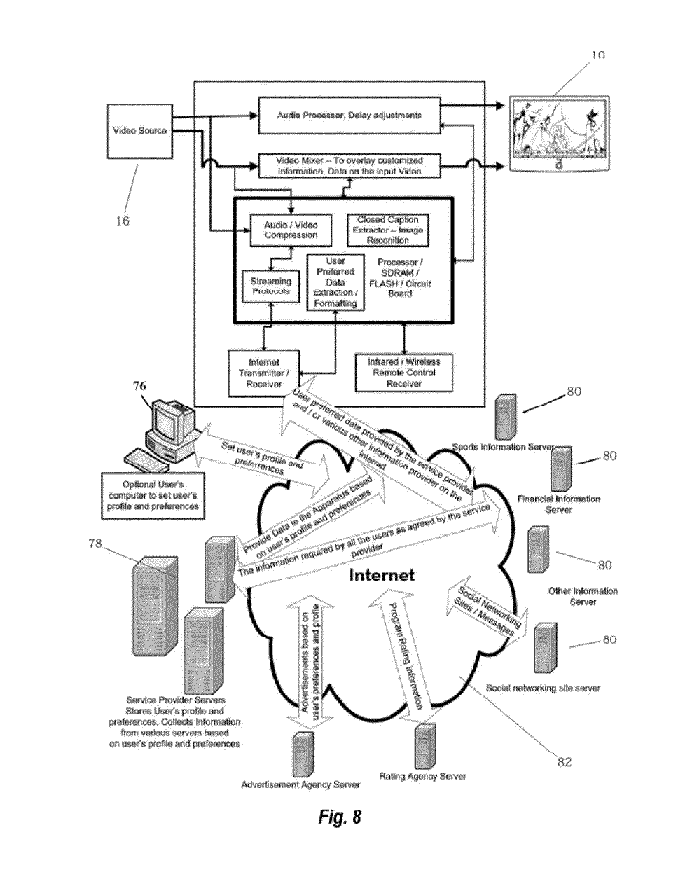

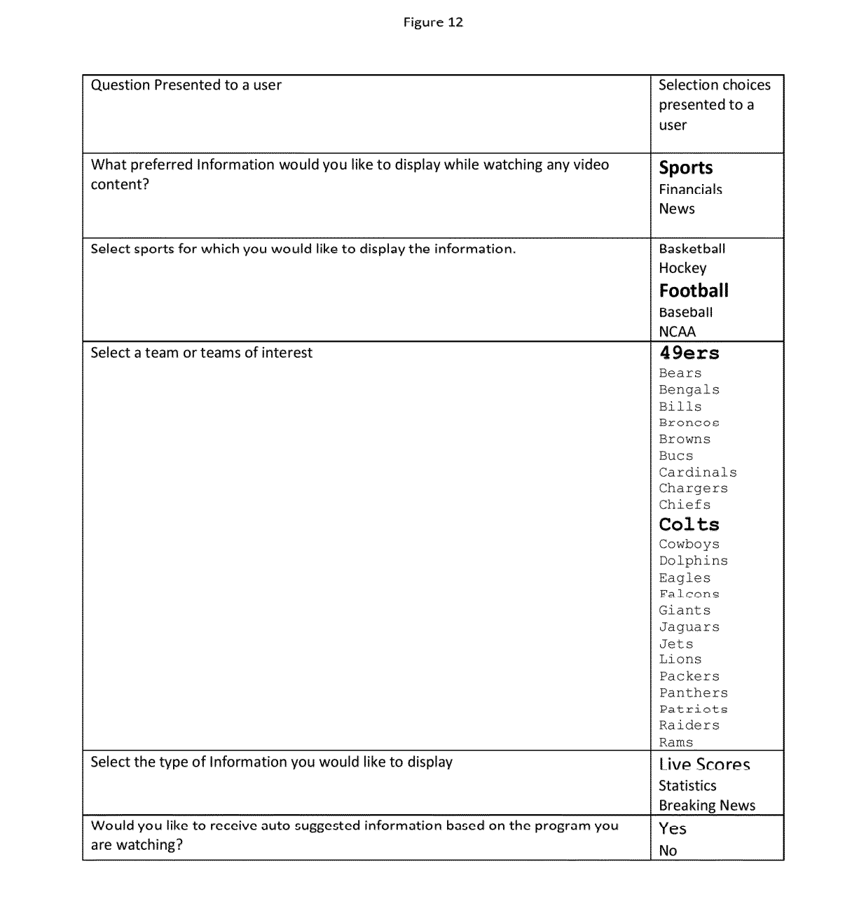

FIG. 8 is a schematic view illustrating how a device 18 communicates with several data providers on the internet 82 and collects user-preferred information to be displayed on TV 10. A user's profile and preferences can be set either by remote control 34 or through a user's computer 76. During the process of setting a user's profile and preferences, a user 84 is presented with the menu to specify preferences as best shown in FIG. 12. Device 18 collects information from preprogrammed websites or information servers. This general information is parsed by the device' processor to provide the user's preferred information. Alternatively, the service provider's server collects the information from various websites and sends the user-preferred information to the device 18 based on the user's profile and preferences stored in the service provider's servers 78.

The service provider's servers 78 are used to send the modifications to the device's embedded software to keep the device's software latest. Modifications in the software are required to remove any bugs or to improve or modify any of the services based on user's profile and preferences. The device 18 receives the latest software and upgrades itself with the latest software.

Information providers 80 can be of many types like sports information, financial information, weather information, traffic information, movies in the area, food available in the area, and so on.

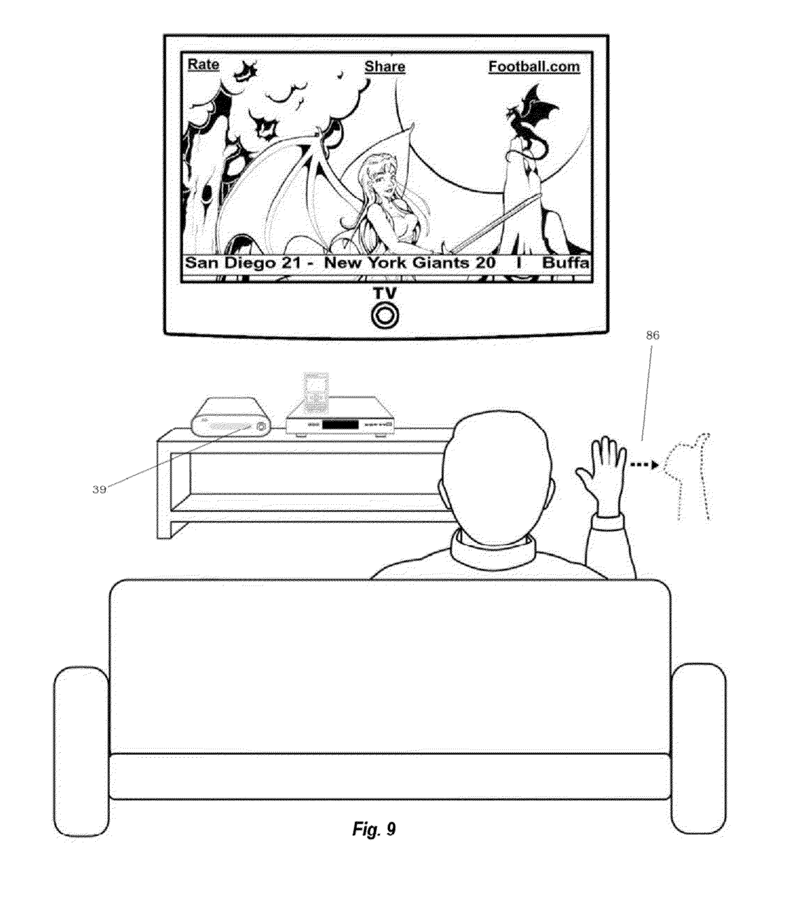

FIG. 9 is a representation view of the device 18 with video camera 39 capturing user's gesture. When a user 84 performs hand gesture 86, the video camera 39 captures hand movement and provides the signal to the video processor in the device 18.

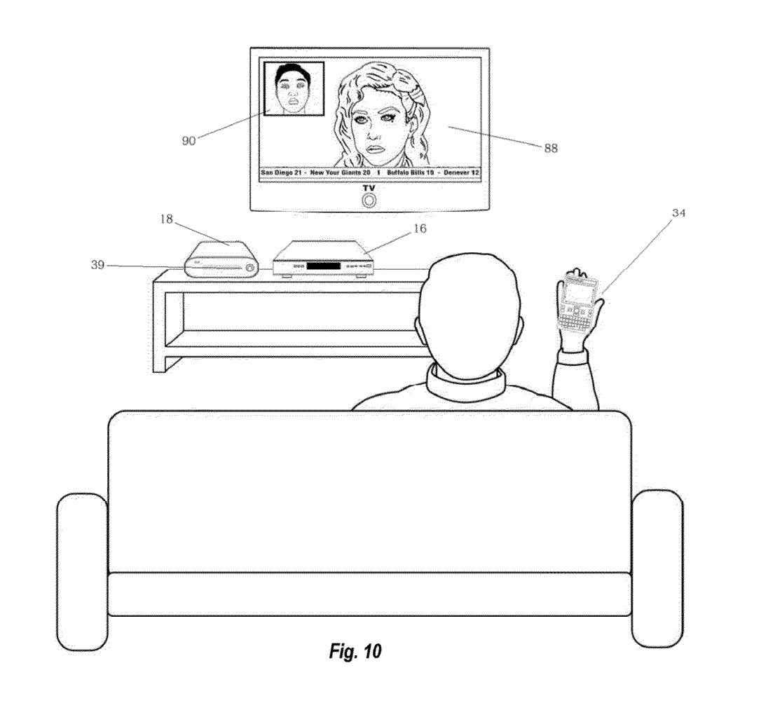

FIG. 10 is a representation view of the device 18 in the video conference mode. TV 10 shows user's own video 90 in a window and video of remote person 88 or persons on the video conference call.

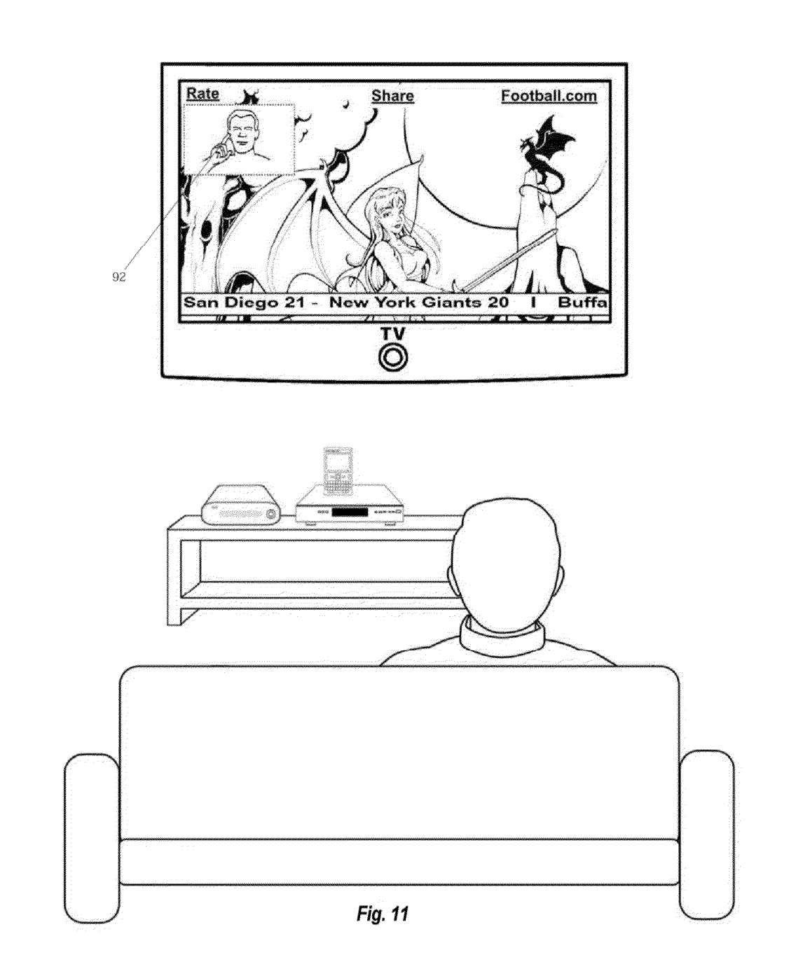

FIG. 11 is a representation view of the device 18 converting audio input 40 to the device 18 into sign language presentation 92. Sign language presentation 92 is presented by an animated character. The animated character is generated by the video processor.

FIG. 12 is a representational view of the menu items which may be presented to user 84 to allow the user to input and specify their preference for the information each respective user would like to view while watching any TV program. This typical menu is presented to a user 84 when the user signs up for the services first time. Once a user 84 starts to use services, a user can modify preferences by logging into a specified website or when a user selects “Preferences” from menu displayed on the TV 10 displayed through the device 18.

User uses mouse and keyboard to select the preferences when selecting preferences through the computer or using remote control when using the device 18. User can also use his mobile phone type of device to log into the website and specify preferences. Alternatively, some mobile phones may also provide downloadable applications to specify the preferences. Preferences are associated with the user's user name. The preferences may be protected by other users with the assignment of a password.

While all of the fundamental characteristics and features of the disclosed method and apparatus for adding user preferred information to television and entertainment viewing, with reference to particular embodiments thereof, have been shown and described, a latitude of modification, various changes and substitutions are intended in the foregoing disclosure. It will be apparent that in some instance, some features of the invention may be employed without a corresponding use of other features, or steps may be rearranged for operations, without departing from the scope of the invention as set forth. It should be understood that any such substitutions, modifications, and variations, may be made by those skilled in the art, without departing from the spirit or scope of the invention. Consequently, all such modifications and variations are included within the scope of the invention as defined herein.

What is claimed is:

1. A method for provision of user preferred information concurrently with displayed programs on a video display, comprising the steps of:
a. ascertaining user information to be displayed with video on an electronic video display;
a. obtaining the user information from the Internet;
b. utilizing a processor to overlay the user information on the input video displayed on the electronic display in a composite image; and
c. displaying the input video overlaid said user information on the electronic video display.

2. The method of claim 1, additionally comprising:
employing a microprocessor running software adapted to format said user information for said overlay to be displayed concurrently with said input video.

3. The method of claim 1, additionally comprising:
employing software to derive said user information from remote sources over a wide area network.

4. The method of claim 2, additionally comprising:
employing analyzing software upon said processor to analyze said input video to identify a subject matter of said input video; and
employing software to search and obtain said user information which is relevant to said subject matter from the internet.

5. The method of claim 1 additionally comprising:
employing said processor to compress said video and audio signal.

6. The method of claim 5, further comprising:
streaming the compressed video and audio to an internet communication port.

7. The method of claim 1 additionally comprising:
employing said processor to generate and overlay the web-link on the input video displayed on the electronic display.

8. The method of claim 1, additionally comprising:
employing said processor to generate and overlay a rating link on the input video displayed on said electronic display.

9. The method of claim 1, additionally comprising:
employing said processor to generate and overlay a media sharing link on the on the input video displayed on said electronic display.

10. The method of claim 1, additionally comprising:
employing a display which is not a television.

11. The method of claim 1, further comprising:
capturing video of a said user through a video camera; and
recognizing hand gestures of said user to provide user interface.

12. The method of claim 1, further comprising:
capturing video of a said user through video camera; and
providing a video conference facility.

13. The method of claim 1, further comprising:
capturing video of a said user through two video cameras placed appropriately; and providing 3D video conferencing facility.

14. The method of claim 1, additionally comprising:
utilizing said processor and said software to convert speech into actions of a character;
employing said actions to animate sign language upon said video display.

15. The method of claim 1 additionally comprising:
employing said processor to covert sign language of a said user into speech; and
communicating said speech to a second party in a video conference.

16. The method of claim 1, additionally comprising:
employing said processor to acquire videos from the internet; and
displaying said videos in a window formed in said overlay.

17. The method of claim 1, additionally comprising:
employing said processor to store video program watching habits of a user in an electronic memory;
creating a database of the video programs being watched by each said user;
analyzing video program viewing habits dependent on the day and time of the program being watched by a said user;
providing said user information of the video programs available on the TV network;
on the internet, comparing program information with the stored video program viewing habits of a said user to thereby provide a means to provide a suggestion of a video program a said user would like to watch, at a given day and time; and
presenting to the said user, the suggestion of the video programs a user may like to watch.

18. A device comprising:
a communication port to communicate with the internet;
a remote control receiver;
a video input;
a video output; and
a processor configured for:
accessing internet to obtain information;
formatting the obtained information; and
overlaying the formatted information on the input video.

19. of claim 18, further comprising:
audio video data compressor;
streaming the compressed video to a mobile device over local area network

20. The device as recited in claim 18, further comprising:
an image processor;
analyzing the video and acquiring additional relevant internet data and displaying on the TV.

21. The device as recited in claim 18, further comprising:
an audio processor, for synchronizing the audio with the video by adding the time delay to take into account the delay (if any) introduced by the video processor.

22. The device as recited in claim 18, further comprising:
an audio processor, for analyzing the audio of the video being played and converting the audio into an action of animated character.

23. The device as recited in claim 18, further comprising:
a video program relevant or user-preferred data relevant web-link, for enabling the user to get relevant information on the TV by selecting the web link with the remote control.

24. The device as recited in claim 18, further comprising:
a video rate-link, for the customer to rate the program and share the ratings with the social networking sites and/or agency collecting rating information.

25. The device as recited in claim 18, further comprising:
a video share-link, for sharing the video and TV program information with other people.

26. A method and device for adding additional information to video on TV, comprising:
an audio processor;
a video mixer;
a program information extractor;
an internet connectivity;
a video input;
an audio input;
a video output;
an audio output;
a network streaming protocols;
an audio/video compressor;
additional information data extractor and formatter;
a video program relevant web-link displayed on the TV;
additional information relevant web-link;
a video rating-link displayed on the TV; and
a video sharing-link displayed on the TV.
